(19) United States
(12) Patent Application Publication
(10) Pub. No.: US 2009/0045945 A1
(43) Pub. Date: Feb. 19, 2009

(54) Multi-oscillator apparatus for reduced power consumption and related method thereof

(76) Inventor: Hsin-Chung Yeh, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/837,547

(22) Filed: Aug. 13, 2007

(51) Int. Cl. H04Q 7/00

(52) U.S. Cl. 340/539.13

(57) ABSTRACT

An apparatus includes a first oscillator; a first counter coupled to the first oscillator for counting cycles of a signal generated from the first oscillator to thereby generate a cycle number of the first oscillator; a second oscillator; a second counter coupled to the second oscillator for counting cycles of a signal generated from the second oscillator to thereby generate a cycle number of the second oscillator; and a processor coupled to the first counter and the second counter, for determining a formula to model the cycle number of the first oscillator according to the cycle number of the second oscillator, and utilizing the formula and a current cycle number of the second oscillator to obtain a prospect current cycle number of the first oscillator.

### BACKGROUND

The present invention relates to navigation systems, particularly, to a multi-oscillator apparatus for reduced power consumption.

Advancements in satellite technology have allowed for the development of global navigation satellite systems (GNSS), such as global positioning system (GPS), Galileo, etc. These satellite navigation systems involve satellites orbiting the earth, where they transmit radio signals to allow receivers to determine their location, speed and time information. A GNSS receiver, for instance calculates its location by measuring time delays between transmission and reception of GNSS radio signals between satellites, knowing that the signals travels at a known speeds. By determining the position of, and distance to, at least four satellites, the receiver can compute its location. The usefulness of GNSS systems and similarly related devices has lead to an increase in popularity and use over recent years.

Satellite navigation systems typically use a hardware configuration consisting of two system clocks, as illustrated in FIG. 1. A GNSS receiver 100 consists of a first clock 110, a second clock 120, a radio frequency (RF) receiver 130, a baseband module 140 and a processor 150. The first clock 110 is typically a high precision oscillator of a tens MHz level clock range, and is required in order to properly synchronize and receive satellite signals. It is used for various tasks such as frequency down conversion, pseudo range measurement, signal acquisition, and tracking. Additionally, after navigation fix, a clock model of the first clock 110, or its relation term to UTC (universal time coordinate), can be determined from the time information of the navigation fix. The clock model is usually a second order polynomial. The model keeps good accuracy when navigation fix is obtained continuously. And the model of the first clock 110 is usually used for high precision 1 PPS output and good signal reacquire performance. Due to its intrinsic characteristics and usage, the first clock 110 also tends to draw a substantial amount of current when in operation. The second clock 120 is a real time clock of the system, usually being 32.768 KHz and used to provide a clock signal to the processor 150. The second clock 120 usually works with aiding information, such as ephemeris and almanac data for satellite receivers, and is usually cheaper and less accurate than the first clock 110.

The clock model of the first clock 110 is usually inside the processor 150 and is maintained and calculated by a software program in processor 150. In a conventional GNSS receiver, there is no way to build a clock model for the second clock 120, even at a navigation fix condition. Once the GNSS receiver 100 (or the first clock 110) is turned off, the clock model of the first clock 110 can no longer be maintained. When the receiver 100 (or the first clock 110) restarts, the receiver 100 can only rely on rough time information from the second clock 120 and the stored aiding information such as ephemeris, almanac and rough position information. (Information stored in non-volatile memory of processor 150 or obtained form an assistance network). The restart performance (in a satellite navigation system, performance usually means sensitivity and time to first fix, TTFF) is restricted greatly by the rough time information at actual work. Because batteries in portable GNSS receivers have a limited power supply, applications that need to stop the first clock 110 for power savings and require a fast resume of navigation have recently become popular at an amazing scale. The claimed invention proposes a method and apparatus for building up a second clock model of the second clock 120 at navigation fix stage and used the second clock model for enhancing restart up performance that meets the power saving trend mentioned above.

### SUMMARY

According to an exemplary embodiment of the claimed invention, an apparatus is disclosed. An apparatus comprises a first oscillator; a first counter coupled to the first oscillator for counting cycles of a signal generated from the first oscillator to thereby generate a cycle number of the first oscillator; a second oscillator; a second counter coupled to the second oscillator for counting cycles of a signal generated from the second oscillator to thereby generate a cycle number of the second oscillator; and a processor coupled to the first counter and the second counter, for determining a formula to model the cycle number of the first oscillator according to the cycle number of the second oscillator, and utilizing the formula and a current cycle number of the second oscillator to obtain a prospect current cycle number of the first oscillator.

According to another exemplary embodiment of the claimed invention, a method for using in an apparatus having a first oscillator and a second oscillator is disclosed comprising counting cycles of a signal generated from the first oscillator to thereby generate a cycle number of the first oscillator; counting cycles of a signal generated from the second oscillator to thereby generate a cycle number of the second oscillator; determining a formula to model the cycle number of the first oscillator according to the cycle number of the second oscillator; and utilizing the formula and a current cycle number of the second oscillator to obtain a prospect current cycle number of the first oscillator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a basic hardware configuration of a satellite navigation system according to the prior art.

FIG. 2 is an apparatus 200 for reducing power consumption according to an embodiment of the present invention.

FIG. 3 is a process flow chart illustrating a method 300 for using in an apparatus having a first oscillator and a second oscillator according to an embodiment of the present invention.

### DETAILED DESCRIPTION

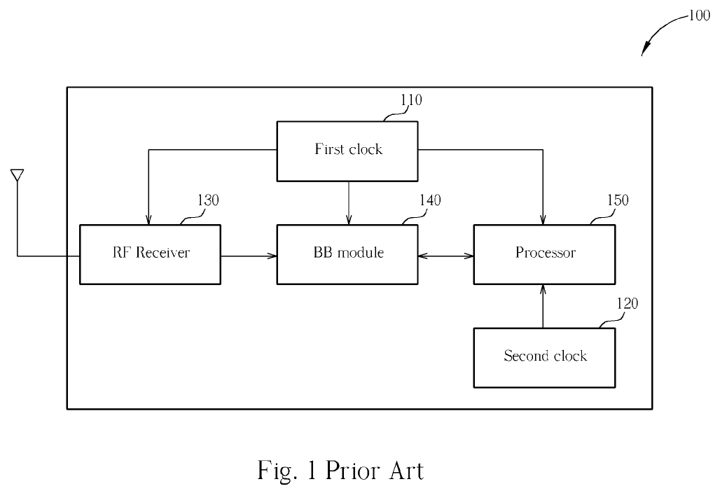

In order to enhance system restart performance and reduce current draw and power consumption in multi oscillator systems, the present invention discloses a method and a multi-oscillator apparatus. As illustrated above and through FIG. 1, the first clock 110 in prior art satellite navigation systems is always active, while drawing a substantial amount of current to provide a continuous navigation service. For example, if the first clock 110 is a temperature compensated oscillator (TCXO), it would typically have a 1.5 to 2 mA current draw. Although a designer may want to disable the first clock 110 to be in a standby mode for power savings, this is difficult because there is no longer a valid clock model which guarantees a fast restart up performance at high confidence. The present invention therefore provides an apparatus and related method that allows the temporary disabling of the first clock in order to ease the design of stop receiving and fast resume which can greatly reduce current draw and provide good flexibility for most applications.

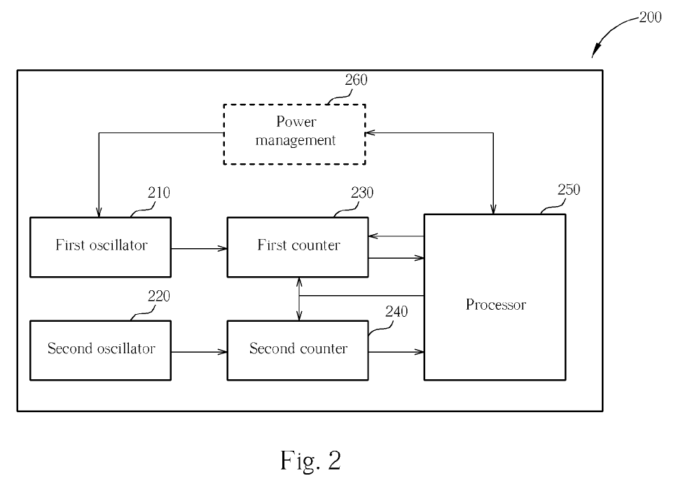

FIG. 2 is a preferred embodiment of the present invention apparatus 200 for ease the design of reducing power consumption. The apparatus 200 includes: a first oscillator 210, a first counter 230 coupled to the first oscillator 210 for counting a cycles of the first oscillator as the cycle number of the first oscillator, a second oscillator 220, a second counter 240 coupled to the second oscillator 220 for counting cycles of the second oscillator as the cycle number of the second oscillator, and a processor 250 coupled to both the first counter 230 and the second counter 240. Additional embodiments may also include a power management device 260 coupled between the first oscillator 210 and the processor 250.

The first counter 230 and second counter 240 are included in the apparatus 200 to act as timers (for example, a millisecond counter) that can be used by different routines of the processor 250. At the navigation fix condition, a clock model between the first counter 230 and UTC is obtained by processor software (or hardware) which facilitates signal reacquisition in the temporary blocking of satellites. In other words, keeping the first clock model at a power cease period of the first clock 210 can help with fast reacquisition of satellites at its resume condition. As described in the prior art, the first oscillator 210 must usually remain active at all times. Once the power stops for the first clock 210, the first model in processor 250 no longer exists. This is in part due to the necessary maintenance of the counters for continuously keeping track of timing values. Accurate counter values are necessary for narrowing down the search space of reacquiring satellite signals, which therefore necessitate the oscillators remaining active at all times. The following description details how the present invention apparatus 200 allows for the temporary disabling of the first oscillator 210 to facilitate power reduction.

During normal operation, while all components of the apparatus 200 are active, the processor 250 determines a formula to model the cycle number of the first oscillator according to the cycle number of the second oscillator. In this way, a prospect cycle number of the first oscillator in the first counter 230 can be attained for a given cycle number of the second oscillator in the second counter 240. Once obtained, the processor 250 then is able to disable the first oscillator 210 up to user specific application, for example, to stop operation or enter a temporarily standby mode, where power reduction is achieved. During the standby mode; however, the second clock 220 and the second counter 240 remain active, as the second counter 240 precisely maintains the cycle number of the second oscillator at all times. When operation of the first oscillator 210 is required (such as for receiving a satellite signal in a satellite system), according to one exemplary method, the processor first loads the first counter 230 according to the formula and the current cycle number of the second oscillator, and then enables the first oscillator 210. This allows the first counter 230 to resume counting the cycle number of the first oscillator starting from the loaded value. Because the first counter 230 was loaded with the prospect cycle number based on the formula and the current cycle number of the second oscillator, the cycle number of the first oscillator should be similar to that as if no interruption was caused through the temporary disabling of the first oscillator 210. This allows for a seamless disabling and enabling of the first oscillator 210, as the first counter 230 is updated during required operation of the apparatus 200.

When the first counter 230 is loaded and the first oscillator 210 is enabled, the accuracy of the cycle number of the first oscillator is dependent on the modeled formula, stop time and the precision of the second oscillator 220 (or also second counter 240). However, a slight discrepancy of the first counter would obviously be less of a concern compared to a situation in the prior art where there is no reference time frame at all. Therefore, the formula that has been appropriately modeled can help to reduce uncertainties and ensure better signal search performance at system restart up. Other errors, such as synchronization error, short-term clock jitter, and long term jitter from the real time clock, may also contribute to the overall error in the first counter. These factors can therefore be taken into consideration when choosing the modeling formula to minimize the total potential error.

In one embodiment, the formula is modeled according to a second order polynomial formula when the first oscillator is enabled. The model for the second order polynomial appears below in equation (1)

F₁=aF₂²+bF₂+c (1)

where (F1) represents the cycle number of the first oscillator, (F₂) represents the cycle number of the second oscillator, and (a, b, c) are constants that are determined though sampling points. As a numerical example, suppose three sampling points are taken when the apparatus 200 is fully enabled: (F_{1,1}=1499511, F_{2,1}=375), (F_{1,2}=1999022, F_{2,2}=1375), (F_{1,3}=2498534, F_{2,3}=2375). Thus using equation (1), the constants can be solved from the three data points such that a=0.0000005, b=499.510125, and c=1312194.6328125. Inserting the constants back into equation (1) provides a formula that can approximately determine F₁ at a given F₂. Therefore, if operation of the first oscillator 210 is required at a time when F_{2,4}=32768 after being on standby, the processor 250 would load the first counter 230 according to the formula above, and a current cycle number of the second oscillator (F₂=32768) with the obtained value of F_{1,4}=1073741824.

Alternatively, the formula can be more arbitrarily determined by simultaneously sampling the cycle number of the first oscillator and a corresponding cycle number of the second oscillator at three different times to obtain three pairs of cycle counts. These pairs of oscillation counts are therefore data points used to appropriately model the formula. The formula is therefore modeled provide the sampled cycle number of the first oscillator according to the corresponding cycle number of the second oscillator for each of the three pairs of cycle counts. In this method, the spacing of the sampling points helps is chosen according to the desired modeling resolution. In other embodiments, the present invention can also count more or less than three pairs of cycle counts to fit a higher or lower order polynomial equation as the formula.

Various features can also be applied to the apparatus 200 in additional embodiments. The processor 250 may further enable the first oscillator 210 at a predetermined condition, such as a wakeup time, which can be synchronized with a desired function requiring use of the first oscillator 210. The first oscillator 210 can be a temperature compensated crystal oscillator (TCXO), or an alternate type according to design requirements. The second oscillator 220 can be a real time clock of the apparatus 220.

Also, the power management device 260 that is coupled between the processor 250 and the first oscillator 210, can be used by the processor to disable and enable the first oscillator 210. Finally, in order to maintain power to the apparatus 200 in a standby mode, a battery (not shown) can be included and coupled to the second oscillator 220 and the second counter 240 for supplying backup power when system power of the apparatus 200 is disabled. The processor 250 can then disable the first oscillator 210 by disabling the system power of the apparatus 200.

While the description of the above apparatus is applicable to a wide range of dual oscillator systems, a preferred application is directed towards satellite navigation system where the apparatus 200 is a GNSS receiver. As stated in the prior art, GNSS receiver have a dual oscillator design, where a first oscillator is typically required to be active at all times for satellite signal receiving. However, when applying the apparatus 200 of the present invention to a satellite navigation system, the first oscillator can be temporarily disabled in a power saving mode to reduce power consumption. In this embodiment, the processor 250 is further for enabling the first oscillator 210 prior to receiving a satellite signal for successful reception. The processor is also used for maintaining most updated formula between two clock counters, storing formula parameters in non-volatile RAM, accepting user command to turn the whole system off (except for the second oscillator and second counter) and resuming system operation by using the stored formula and the current second counter value for good restart up performance. Finally, in still another exemplary embodiment, the processor can be used to determine the formula during established satellite navigation, disabling the first oscillator to be in a power savings mode, enable the first oscillator to resume a normal operation mode, compensating the first counter discontinuity (offset) by using software in processor.

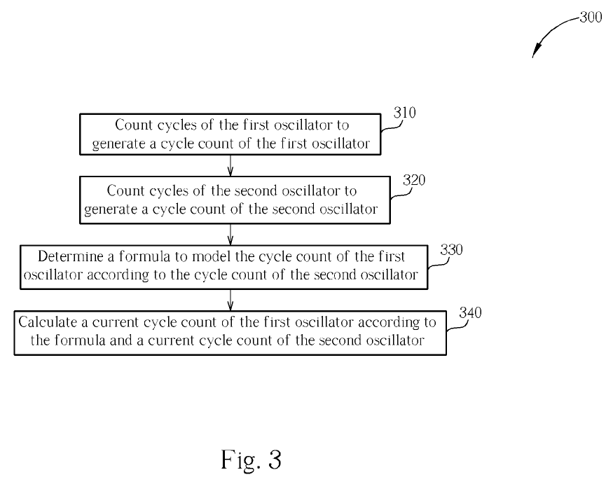

The teachings above can also be applied towards a method 300 for using in an apparatus having a first oscillator and a second oscillator. A flow chart illustrating this method 300 according to an embodiment of the present invention is shown in FIG. 3. Provided that substantially the same result is achieved, the steps of method 300 need not be in the exact order shown and need not be contiguous, that is, other steps can be intermediate. The method for an apparatus having a first oscillator and a second oscillator comprises:
Step 310: Counting cycles of the first oscillator to thereby generate a cycle number of the first oscillator.
Step 320: Counting cycles of the second oscillator to thereby generate a cycle number of the second oscillator.
Step 330: Determining a formula to model the cycle number of the first oscillator according to the cycle number of the second oscillator.
Step 340: Calculating a current cycle number of the first oscillator according to the formula and a current cycle number of the second oscillator.

Additionally, the above teachings can also be applied towards a method for reducing power consumption in an apparatus having a first oscillator and a second oscillator. The first oscillator can be disabled in a power saving mode or a stop service mode.

According to the present invention, when the first oscillator being enabled after the power saving mode or the stop service or after the predetermined condition, the apparatus and method of present invention could re-model the parameters of the formula, such as a, b, and c in equation (1). Of course, the number of parameters determined by the order of the formula. As a result, the formula will be updated when the first oscillator activated.

Through the above teachings, the present invention provides an apparatus and method to reduce current draw and power consumption in a multi oscillator system. By temporarily disabling the first oscillator in the multi oscillator apparatus, power consumption is reduced, and battery life of a multi oscillator system can be extended. Additionally, internal counter and oscillator values can nonetheless be maintained through reference of the modeled formula and second oscillator. The first oscillator can be enabled when required, and operation the apparatus can be seamlessly restored.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus comprising:
a first oscillator;
a first counter coupled to the first oscillator for counting cycles of a signal generated from the first oscillator to thereby generate a cycle number of the first oscillator;
a second oscillator;
a second counter coupled to the second oscillator for counting cycles of a signal generated from the second oscillator to thereby generate a cycle number of the second oscillator; and
a processor coupled to the first counter and the second counter, for determining a formula to model the cycle number of the first oscillator according to the cycle number of the second oscillator, and utilizing the formula and a current cycle number of the second oscillator to obtain a prospect current cycle number of the first oscillator.

2. The apparatus of claim 1, wherein the processor is further for simultaneously sampling the cycle number of the first oscillator and a cycle number of the second oscillator at the same time and repeating such sampling for different times to thereby obtain pairs of cycle counts, and determining the formula to model the cycle number of the first oscillator according to the pairs of cycle counts.

3. The apparatus of claim 1, wherein the first oscillator is disabled at a predetermined time, and the processor is for utilizing the formula to obtain the prospect cycle number of the first oscillator when enabling the first oscillator.

4. The apparatus of claim 1, wherein the first oscillator is a crystal oscillator used for signal processing.

5. The apparatus of claim 1, wherein the second oscillator is a crystal oscillator used for time of day information.

6. The apparatus of claim 1, further comprising a power management device coupled to the processor and the first oscillator, wherein the processor is further for disabling and enabling the first oscillator through the power management device.

7. The apparatus of claim 1 being a satellite navigation system.

8. The apparatus of claim 7, wherein the processor is further for determining the formula during established satellite navigations, then disabling the first oscillator to be in a power savings mode or a stop service mode, loading the first counter according to the formula and the current second number of oscillations at a predetermined condition, and enabling the first oscillator to reestablish satellite navigations.

9. A method for using in an apparatus having a first oscillator and a second oscillator, the method comprising;
counting cycles of a signal generated from the first oscillator to thereby generate a cycle number of the first oscillator;
counting cycles of a signal generated from the second oscillator to thereby generate a cycle number of the second oscillator;
determining a formula to model the cycle number of the first oscillator according to the cycle number of the second oscillator; and
utilizing the formula and a current cycle number of the second oscillator to obtain a prospect current cycle number of the first oscillator.

10. The method of claim 9 further comprising simultaneously sampling the first number of cycles and a second number of cycles at the same time and repeating such sampling for different times to thereby obtain pairs of cycle counts, and determining the formula to model the number of cycles of the first oscillator according to the pairs of cycle counts.

11. The method of claim 9 further comprising disabling the first oscillator at a predetermined time, utilizing the formula to obtain the prospect cycle number of the first oscillator when enabling the first oscillator.

12. The method of claim 9 further comprising determining the formula during satellite signal processing, then disabling the first oscillator to be in a power saving mode or a stop service mode, calculating the current first number of oscillations according to the formula and the current second number of oscillations at a predetermined condition, and enabling the first oscillator to continue counting to reestablish satellite signal processing.
